(19) United States
(12) Patent Application Publication
(10) Pub. No.: US 2012/0127192 A1
(43) Pub. Date: May 24, 2012

(54) METHOD AND APPARATUS FOR SELECTIVE DISPLAY

(75) Inventors: Cheol-Ho CHEONG, Seoul (KR); Kwang-Young KIM, Suwon-si (KR); Kyoung-Keun PARK, Seoul (KR)

(73) Assignee: SAMSUNG ELECTRONICS CO., LTD., Suwon-si (KR)

(21) Appl. No.: 13/300,437

(22) Filed: Nov. 18, 2011

(30) Foreign Application Priority Data
Nov. 22, 2010 (KR) 10-2010-0116019

(51) Int. Cl. G09G 5/02; G09G 5/00

(52) U.S. Cl. 345/589; 345/581

(57) ABSTRACT

A method and apparatus provide selective display. The method includes acquiring region setting information in a display screen, acquiring a screen configuration element in the display screen, dividing the display screen into at least one region based on the region setting information and the screen configuration element, setting a screen attribute to each of the at least one region divided based on the region setting information and the screen configuration element, and controlling each pixel of the at least one region according to the set screen attribute and displaying information.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 22, 2010 and assigned Serial No. 10-2010-0116019, the entire disclosure of which is hereby incorporated by reference.

### TECHNICAL FIELD OF THE INVENTION

The present invention relates to selective display. More particularly, the present invention relates to a method and apparatus for, at a time of display, receiving a selection of a predetermined display region, performing each different display control according to the selected display region and a non-selected display region, and providing various display services in an electronic device.

### BACKGROUND OF THE INVENTION

A technology for controlling the visibility of a screen in a display device by receiving a selection of a specific region and applying or not a supply of electric current of picture elements (pixels) corresponding to the specific region is being provided. An organic light-emitting diode can provide an effect of saving electric currents by cutting off a power source for pixels corresponding to a non-selected region.

Presently, this technology is the extent of displaying or hiding a specific region or turning On/Off a display of a corresponding region according to a user input such as a touch.

This technological aspect has a problem of making it difficult to provide various display services according to a user's surrounding or a configuration of contents of displayed various texts, images, moving pictures and the like.

### SUMMARY OF THE INVENTION

To address the above-discussed deficiencies of the prior art, it is a primary aspect of the present disclosure is to provide a method and apparatus for selective display.

Another aspect of the present disclosure is to provide a display control method and apparatus conforming to a user's intention by giving each different display characteristic, i.e., each different brightness, color, and shade to one or more regions selected by a User Interface (UI) and a region other than the selected regions in a display device.

A further aspect of the present disclosure is to provide a display control method and apparatus suitable to a characteristic of contents by determining displayed elements and giving a regional display characteristic considering a characteristic of a configuration element in a display device.

Yet another aspect of the present disclosure is to provide a method and apparatus for, by providing a method and apparatus for selective display, reducing current consumption, giving a function of protection of user information, and providing an inquiry service and a service such as a reading lamp function in a display device.

Still another aspect of the present disclosure is to provide a method and apparatus for providing a service desired by a user, by analyzing a configuration of displayable contents, dividing a display region considering setting or input by a UI together and, every each region, controlling colors, shades, and brightness of pixels constituting this in a display device.

The above aspects are achieved by providing a method and apparatus for selective display.

According to one aspect of the present disclosure, a method for selective display is provided. The method includes acquiring region setting information in a display screen, acquiring a screen configuration element in the display screen, dividing the display screen into at least one region based on the region setting information and the screen configuration element, setting a screen attribute to each of the at least one region divided based on the region setting information and the screen configuration element, and controlling each pixel of the at least one region according to the set screen attribute and displaying information.

According to another aspect of the present disclosure, an apparatus for selective display is provided. The apparatus includes a region setting information generator, a screen configuration element analyzer, a region divider, a regional screen attribute setting unit, and a display unit. The region setting information generator acquires region setting information in a display screen. The screen configuration element analyzer acquires a screen configuration element in the display screen. The region divider divides the display screen into at least one region based on the region setting information and the screen configuration element. The regional screen attribute setting unit sets a screen attribute to each of the at least one region divided based on the region setting information and the screen configuration element. The display unit controls each pixel of the at least one region according to the set screen attribute, and displays information.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates an example of region selection according to an exemplary embodiment of the present disclosure;

FIG. 1B illustrates an example of region selection according to an exemplary embodiment of the present disclosure;

FIG. 1C illustrates an example of region selection according to an exemplary embodiment of the present disclosure;

FIG. 1D illustrates an example of region selection according to an exemplary embodiment of the present disclosure;

FIG. 2A illustrates another example of region selection according to an exemplary embodiment of the present disclosure;

FIG. 2B illustrates another example of region selection according to an exemplary embodiment of the present disclosure;

FIG. 2C illustrates another example of region selection according to an exemplary embodiment of the present disclosure;

FIG. 2D illustrates another example of region selection according to an exemplary embodiment of the present disclosure;

FIG. 3A illustrates a further another example of region selection according to an exemplary embodiment of the present disclosure;

FIG. 3B illustrates a further another example of region selection according to an exemplary embodiment of the present disclosure;

FIG. 3C illustrates a further another example of region selection according to an exemplary embodiment of the present disclosure;

FIG. 3D illustrates a further another example of region selection according to an exemplary embodiment of the present disclosure;

FIG. 4A illustrates an example of screen display when selecting two or more regions through a User Interface (UI) according to an exemplary embodiment of the present disclosure;

FIG. 4B illustrates an example of screen display when selecting two or more regions through a User Interface (UI) according to an exemplary embodiment of the present disclosure;

FIG. 4C illustrates an example of screen display when selecting two or more regions through a User Interface (UI) according to an exemplary embodiment of the present disclosure;

FIG. 4D illustrates an example of screen display when selecting two or more regions through a User Interface (UI) according to an exemplary embodiment of the present disclosure;

FIG. 5 illustrates an operation process for selective display according to an exemplary embodiment of the present disclosure;

FIG. 6 illustrates object attribute information according to an exemplary embodiment of the present disclosure;

FIG. 7A illustrates an operation process of the disclosure according to an exemplary embodiment of the present disclosure;

FIG. 7B illustrates an operation process of the disclosure according to an exemplary embodiment of the present disclosure;

FIG. 7C illustrates an operation process of the disclosure according to an exemplary embodiment of the present disclosure;

FIG. 7D illustrates an operation process of the disclosure according to an exemplary embodiment of the present disclosure;

FIG. 8 illustrates an operation for an electronic book (e-book) service according to an exemplary embodiment of the present disclosure; and

FIG. 9 illustrates a construction of an apparatus according to an exemplary embodiment of the present disclosure.

### DETAILED DESCRIPTION OF THE INVENTION

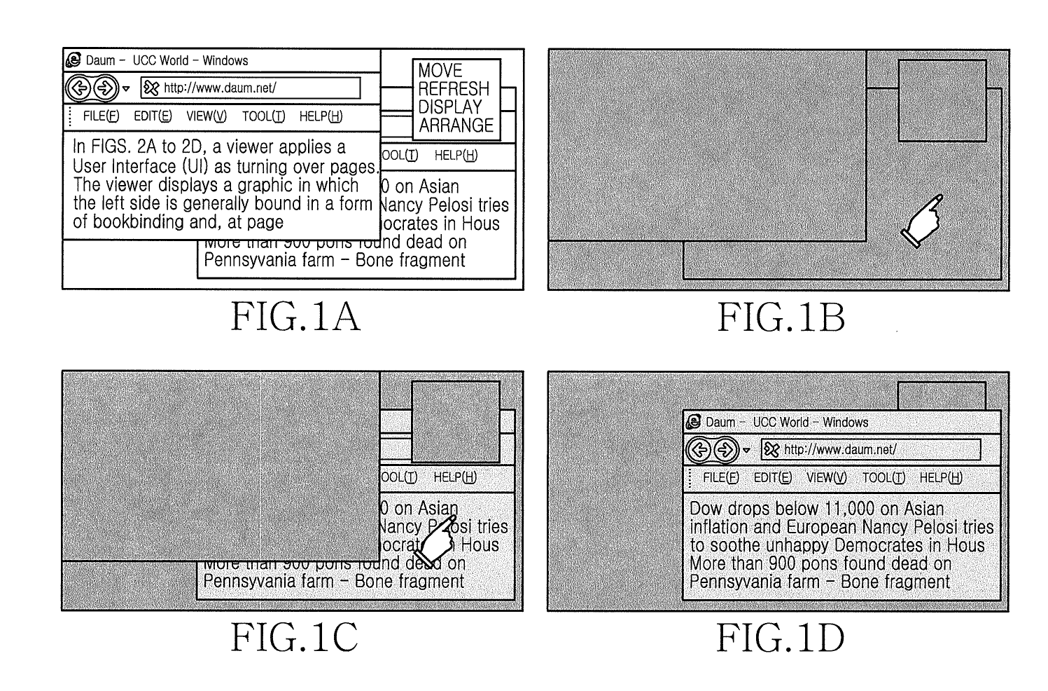

FIGS. 1A through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Below, exemplary embodiments of the present disclosure provide a method and apparatus for selective display.

To output an object such as a window, a text, an image, a layout, a moving picture, a status bar, an icon, a menu and the like, a display system now widely used should have position information of an object to be output to a corresponding display.

There is a case that only some of the objects are displayed since the objects are overlapped with each other, or there is a case that all of the objects cannot be displayed since the objects are hidden by different objects. Accordingly, at a time of display, there is a need to output something reflecting characteristics of these objects.

FIGS. 1A-D illustrate an example of region selection according to an exemplary embodiment of the present disclosure.

FIG. 1A illustrates a general computer screen. Basically, FIG. 1B illustrates an example of facilitating user's object selection by illustrating only a boundary portion in a state of blackening a screen of FIG. 1A. At this time, this boundary is displayed considering position information of each object and its relationship, i.e., which object covers a different object and the like, and is not illustrated when the boundary is not displayed because being covered by a different object. A method of expressing a boundary of an object can be a method of extracting a boundary from image information stored in a buffer memory and processing, or a method of extracting an outline using position information and size information of an object stored in a buffer memory and the like.

FIG. 1C is an example where one (e.g., a document editor window) of three windows is selected through a touch, a mouse, a keypad, an eye tracking device and the like, and illustrates an example of displaying at luminance greatly reduced so as to show if a corresponding window is which one. At this time, if another window is selected, after the document editor window is again blackened, only a boundary is illustrated, and the substance of the newly selected window is displayed identically.

FIG. 1D is an example where the selected document editor window of FIG. 1C is selected once again. This can be achieved even by double clicking in the state of FIG. 1B or through a double touch, a long press and the like. This represents that a corresponding window has been selected and activated, and represents a state where a menu bar belonging to the corresponding window, a tool bar, a status bar, a document viewer frame and the like also are selectable while their boundaries are displayed.

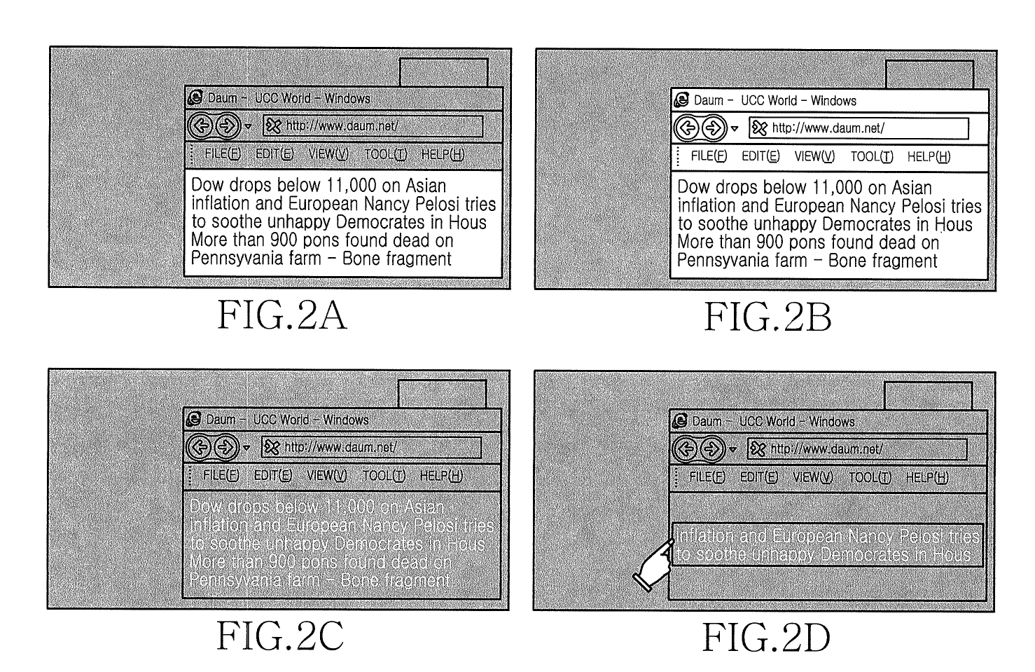

FIGS. 2A-D illustrate another example of region selection according to an exemplary embodiment of the present disclosure.

FIG. 2A illustrates one example of a scene in which a user selects and activates a document editor window of FIG. 1D. In this example, the document editor window is restored to the original luminance. FIG. 2B illustrates an example of setting the original luminance to the entire region of a selected window, and can be shown in place of FIG. 1D when selecting a corresponding window in a state of FIG. 1C or can be shown when selecting all objects of a corresponding window in a state of FIG. 1D. Regarding this, it is desirable that an applying method is preset through a User Interface (UI).

FIG. 2C illustrates an example of turning on pixels constituting a foreground text and turning off a background object in the selected document editor window. This scheme can achieve more efficient reduction of current consumption, and has an advantage of less disturbing other people in a dark environment by showing only an object of a necessary portion in the entire screen.

FIG. 2D illustrates an example of displaying only some texts in the selected document editor window. This is possible when displaying a specific region selected by a user through a UI such as a touch, a click, a key input, a voice input, eye tracking and the like or sequentially outputting each region on a screen during a predetermined time through timer setting and the like. Through this, an object is selected and displayed in a unit of a row, a phrase, a sentence, a paragraph and the like. For example, sentences, rows, and paragraphs can be displayed sequentially in order through the UI or a timer, and the remnant region can be blackened.

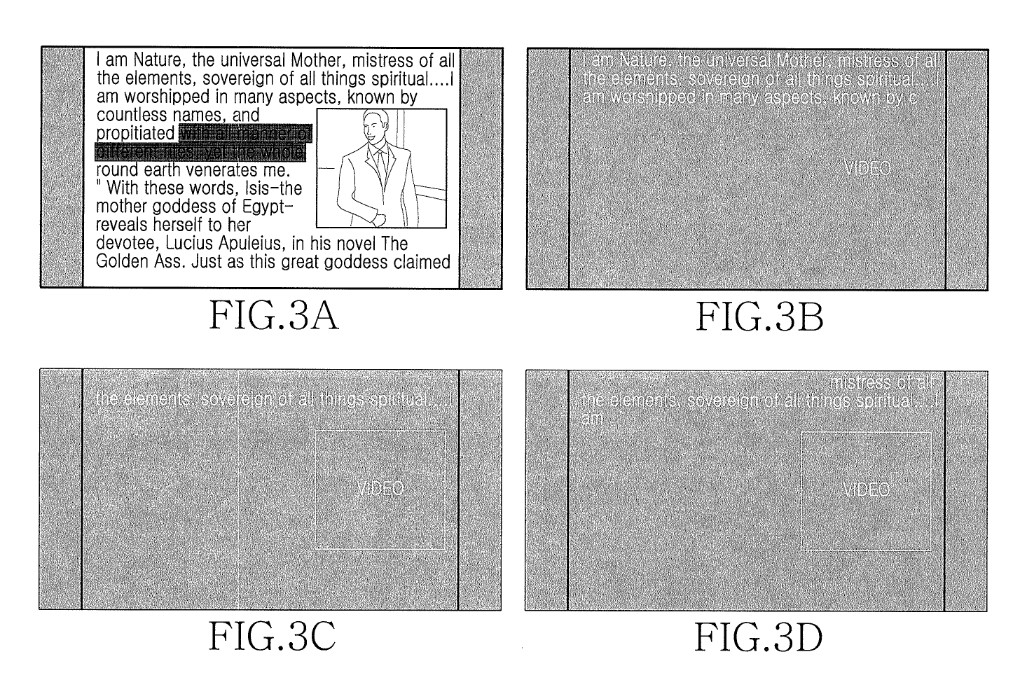

FIG. 3A-D illustrate a further another example of region selection according to an exemplary embodiment of the present disclosure.

FIG. 3A illustrates a general screen, and is displaying contents composed of a text and a moving picture.

FIG. 3B illustrates an example of an operation of the disclosure, and blackens a video region and is outputting a text up to a first sentence in a text region. The screen is displaying a page number and a title of a corresponding page. In an example of an e-book service, presenting a page, a first sentence, and a title in this manner can make it easy to find a page desired by a user.

Accordingly, it is desirable to allow a user to select ever-displayed items, for example, a title, a page, a first sentence, a first word, a first paragraph, a title of a window, a contents title and the like through a UI. Also, FIG. 3B illustrates one example representing that a blackened portion is a video.

FIGS. 3C and 3D illustrate an example of displaying a text in a sentence unit in order. In place of the sentence unit, the text can be displayed in a unit of one or more rows, a unit of one or more columns, a unit of paragraphs, a unit of words and the like, or can be displayed sequentially by means of an input device of a UI or an automatic move dependent on timer setting, or can be displayed through turning over to a next page or automatic scrolling. Undoubtedly, it is also possible to display a previous region inversely.

These functions may require analysis of contents of a selected region.

In an example of a text, a method of outputting a corresponding region can be varied depending on a language of the corresponding text, a text array form, color information of a corresponding region and the like.

For instance, in English, a text is arranged from left to right and, if a corresponding row is finished, characters are arranged in a lower row. Accordingly, screen output of schemes of FIGS. 3B to 3D is possible. And, to recognize the end of a sentence, there is a need for spaces of more than a predetermined number or search for symbols of ‘.’, ‘:’ and the like that indicate the end of the sentence.

However, in an old Chinese or Japanese book, characters are arranged from top to bottom, i.e., in a column unit, and a column is of order of right to left. Also, even in order of a book page, a right page precedes a left page. In this example, at a time of corresponding screen display, a region should be controlled to be output in order of right to left in the column unit.

In Arabic, characters are arranged from right to left and from top to bottom in a row unit. Regarding a color of a text region, commonly, black characters on a white background are basic and, sometimes, other colors can be used. In this example, it is desirable to turn off pixels of a basic background, or blacken or output at low luminance. And, it is desirable that a text is given colors, luminance, and shades distinguishable from the background. Through this, low power driving and entire luminance decrease can be achieved. As a simple method of realizing this, a negative effect can be given to a text region. That is, white changes into black, and black changes into white. In addition to this, it is desirable to set luminance, colors, and shades to a foreground (i.e., a text), a background, and a character attribute such as an underline, a link mark and the like through a UI, and apply these values when providing a service.

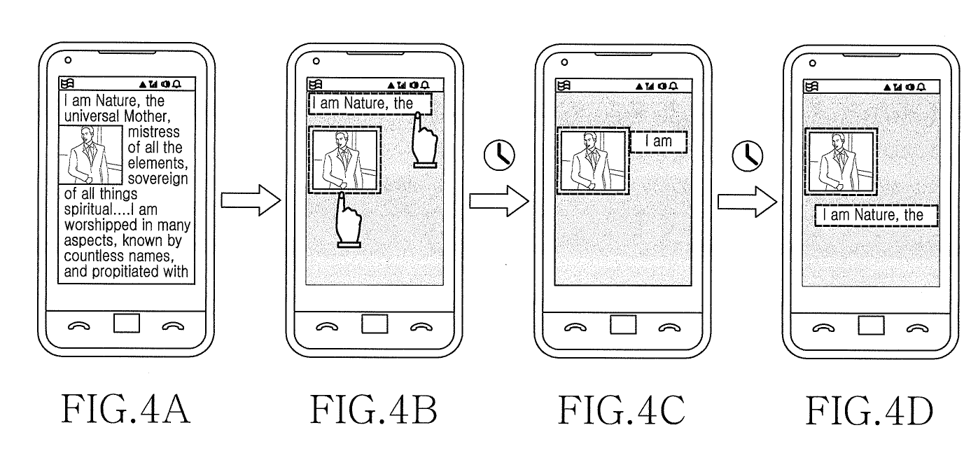

FIG. 4A-D illustrate an example of screen display when selecting two or more regions through a UI according to an exemplary embodiment of the present disclosure.

FIG. 4 illustrates one example in which the remnant region excepting a selected screen is first blackened in the original screen and then is changed depending on the lapse of time.

FIG. 4A illustrates a general screen, and FIG. 4B illustrates a state in which a user selects two different regions and controls to blacken a pixel value of a non-selected region. In this example, setting is possible in various methods such as a multi touch scheme, a key combination scheme, a check box setting scheme and the like. This apparatus analyzes contents being in two different regions and distinguishes an image and a text.

FIGS. 4C and 4D illustrate a movement process of the selected region depending on the lapse of time, and illustrate a process in which only a text displayed is automatically moved depending on the lapse of time as an image is fixed according to the operation result.

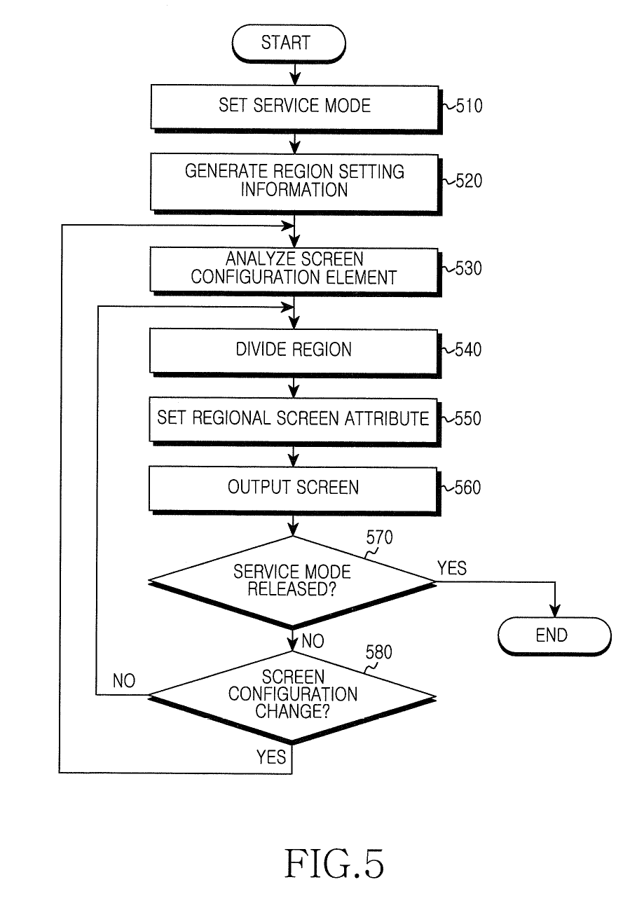

FIG. 5 illustrates an operation process for selective display according to an exemplary embodiment of the present disclosure.

Referring to FIG. 5, in step 510, an apparatus of the present disclosure sets a service mode for selective display. This represents driving a program through a UI or automatically driving according to circumstances.

For example, in an example of theater entrance, flight boarding, night bus boarding and the like, a user sets the corresponding apparatus to a flight mode, a manner mode and the like. In an example where surroundings are very dark at a time of the mode setting, the apparatus can enter a service mode automatically. Or, a user can drive the service mode through the UI.

After that, in step 520, the apparatus generates region setting information. That is, the apparatus determines whether to set any screen attribute to a selected region and a non-selected region, and sets a screen attribute.

The apparatus sets attribute information to be given to each object when there is not a selected region and when there are a selected region and a non-selected region, and determines an attribute to be set according to the relationship between respective objects.

For example, FIG. 2B processes all sub objects belonging to a selected window into selected regions, and illustrates all the objects at the original window luminance. And, FIG. 2C negative-processes a text portion and an image background in a selected window.

Further, FIG. 1C illustrates that, in a state where a selected window is covered with other windows, only its luminance is controlled slightly bright. And, as in FIG. 3, a portion not to be displayed in an object can be displayed only with the kind of corresponding contents and a boundary. In FIG. 3, a timer is used, and a display region can be changed depending on the timer. This processing may be preset through a UI.

For instance, if an apparatus or application is driven, in an example where a specific region is not selected in an initial state, the apparatus can preset, through a UI, a basic processing method such as blackening all a screen for selection, displaying a boundary portion although blackening the screen, or displaying a first sentence together with displaying contents of a selected region as in FIG. 3B.

In an example where the apparatus can detect the substance of contents, the apparatus can preset a display method according to a characteristic of corresponding contents. For example, the apparatus can previously determine a row unit, a column unit, the directionality of a display region and the like according to the kind of a language. Also, the apparatus can determine output or non-output and the like according to the kind of contents. That is, the apparatus can set display or non-display for each of a text, a video, an audio, an image, a UI and the like, or can preset a basic value.

After that, in step 530, the apparatus generates a screen configuration element. The apparatus analyzes attribute information of position information of each object, inter-relationship information, the kind of an object and the like, and stores this in a storage unit.

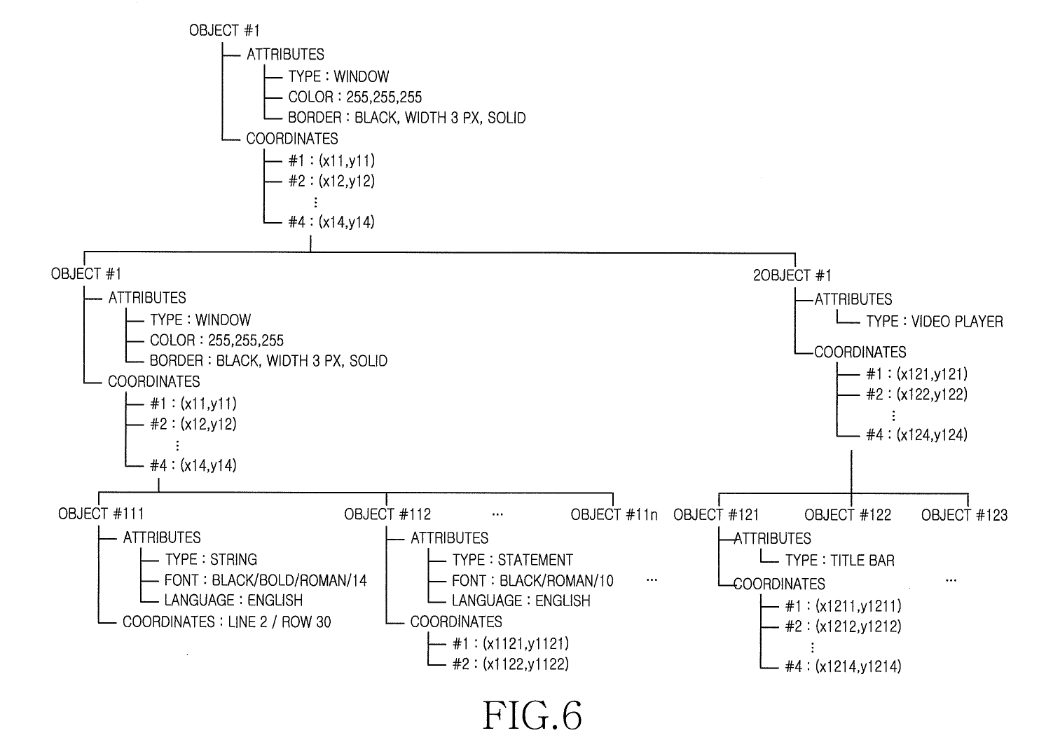

FIG. 6 illustrates one example of attribute information of objects constituting a screen of FIG. 3A. FIG. 6 illustrates that a text window (object #1) has a text window type object (object #11) and a video player object (object #12). Also, FIG. 6 illustrates that each object includes each sub objects, and illustrates the relationship of respective sub objects, positions, characteristics and the like.

This analysis result of the screen configuration element is not necessarily a tree structure, and is possible if including configuration element attribute information according to a characteristic of an application or system such as a linked list capable of distinguishing respective objects, a simple text, a database, a structured document distinguished by tag information and the like.

For instance, if only a simple text is displayed, the system is also possible to simply record a row number. Also, the system has no need to analyze all these object information at a time, and may analyze sub objects in real time according to what a present range of information of a necessary object is.

For instance, in FIGS. 1B and 1C, only boundary information of the outermost edge in each object is needed and, in FIG. 1D, information of sub objects of a specific object may be required for the first time, so, at this time, it is enough to analyze and display the information of the sub objects. This screen configuration element analysis can mainly use two methods as follows.

The first method, which is an example where there is not information of respective objects constituting a screen, is to use a screen image stored in a buffer or memory constituting a screen, i.e., in a display buffer or a memory of a main memory device. At this time, it is enough to, after determining an outline of each object on a screen, determine the inclusion relationship of each object using color information and the like and generate a hierarchical structure of objects.

That is, this is identical with detecting a specific thing using texture patterns, edges, colors and the like, performing localization, and recognizing an independent entity. This is also called object extraction. Particularly, in an example of a window system, since vertical and horizontal segments and objects constituting each window make use of predefined colors, if using these, relatively easy determination is possible.

From the original image of FIG. 1, it can be appreciated that a background image of a corresponding screen is an image with a very complex pattern. Applying, a horizontal/vertical edge detection technique such as a Solbel technique and the like can eliminate a considerable portion of these patterns and intensively acquire edge lines of a window.

Also, if applying an edge-line detection technique and a color determination technique, even each object determination and the phase relationship between objects can be acquainted and, if applying a USAN technique and the like, corner information and the like can be acquired.

Generally, an object is small in size and is not uniform in shape, but is maintained within a constant interval and size and, if separation from the background is easy, a possibility that this object will be text information is high.

Accordingly, these objects can be confirmed as a text region through grouping together with adjacent objects. If not so, a possibility that it will be of a different type is high, and it can acquire a program title text in a specific pattern, e.g., a title bar from a corresponding object or recognize and specify a specific icon, a button shape and the like using an Optical Character Reader (OCR), a technique of pattern matching and the like.

In most examples, this operation may require a long time, and is unnecessary in many examples, so it is enough to simply confirm information of an object using a boundary of a window including corresponding contents.

The second method is an example where the apparatus detects attribute information such as a position of each object, the kind of an object, a color and the like. This is an example where the apparatus can acquire corresponding attribute information from objects being now in display, and does not require separate image processing, so there is an advantage that easy management is possible.

For example, the apparatus can be aware of a position and size of a window, a configuration element and the like from a handler of a window object, and can determine what the kind of a program being driving a window is and the like. This information acquisition is possible in several methods.

For instance, through a process of managing object information of applications presently shown on a screen, the apparatus can obtain application driving or non-driving and related information.

Also, there is an example where the apparatus drives a specific program and, through this, manages object information of a screen. By activating a Random Access Memory (RAM) resident program, the apparatus can confirm a task and states of applications.

As the simplest example of this, if driving a specific application, the apparatus can automatically display only the corresponding application on a screen in a full screen mode. In this example, if a corresponding application controls only sub objects constituting itself, the entire screen control is possible.

In an example where the apparatus can acquire object information by controlling an application, because the apparatus manages even contents data itself, more various information acquisitions are possible and, according to this, a convenient service is made possible later.

For instance, in an example of a text, the apparatus can be aware of the kind of a language of a corresponding text, font information and the like through a corresponding application. Particularly, this stores this information together in a form of a structured document, an eXtensible Markup Language (XML) document, a Hyper Text Markup Language (HTML) document, a word processor document and the like. So, if using this, the apparatus can provide information to vary a position or range of a display region, a sequence and the like according to the kind of a language and an arrangement method as described above.

Accordingly, in an example where contents analysis is possible in this step, the apparatus can update region setting information according to need.

After that, the apparatus sets information of a pixel unit such that output is possible by performing region division in step 540 and applying a regional screen attribute of an output region according to the region division in step 550.

In the region division (step 540), the apparatus distinguishes selected or non-selected regions from each other. If a region is selected through a UI, the apparatus divides and distinguishes a selected region and a non-selected region from each other.

That is, if receiving an input through a UI in any position on a display, the apparatus sets a range of a region including the position as a selected region using the object information acquired in the screen configuration element analysis step, and sets the other region as a non-selected region.

For instance, if selecting one point in one window, the apparatus can set only a corresponding frame as a region or set the entire window region of an application including the corresponding frame as the selected region using the object information. And, the remnant region is all determined as a non-setting region.

At this time, the apparatus can set two or more regions and, sometimes, may designate a region by a UI irrespective of an object. For example, a user may set a region in a square shape, a circle shape and the like through dragging on a screen. In this step, the UI can receive a user input in real time, or may use preset values.

If a present state is a state of initial driving of the present disclosure, the apparatus can output a screen basically set before an input from a UI. Also, even an example of not needing real-time input by a user such as an example of sequentially displaying a text region automatically by a timer is possible.

Like this, in this step, the apparatus does not necessarily a selected region and can reflect this by preset region setting information. This region setting information can be set through a UI or can be set as any basic information.

For example, if a service mode is now in activation, at an initial stage, it is possible to display even in a scheme of FIG. 1A, 1B, 1C, or 1D according to preset region setting information.

At this time, if it is by a timer scheme, the apparatus can set an output attribute such that automatic screen output of a preset region or scheme is possible through a UI.

For instance, the apparatus can basically select a text as a screen to be displayed on a UI screen, and can perform presetting such that a video, an image, and an audio are hidden.

Regional screen attribute setting is a step of setting the substance of how to control pixels of a screen for the sake of actually displaying according to a selected region and a non-selected region. At this time, the apparatus sets values of corresponding pixels by corresponding region according to preset region setting information. Accordingly, actually, the apparatus sets luminance, colors, and shades in a unit of a pixel and, when luminance is equal to ‘0’, the apparatus can turn off power source of a corresponding pixel.

After that, in step 560, the apparatus displays contents according to a set screen attribute.

If there is no changed item in region division, in this example, it is desirable to wait a change of region selection through a UI.

In this process, if an end condition, that is, a service mode is released or a condition such as power cutoff and the like takes place by a UI in step 570, the apparatus terminates service provision.

After that, if a screen configuration changes in step 580, the apparatus returns to step 530 and again performs screen configuration element analysis and, otherwise, returns to step 540 and again performs a region division work by the UI.

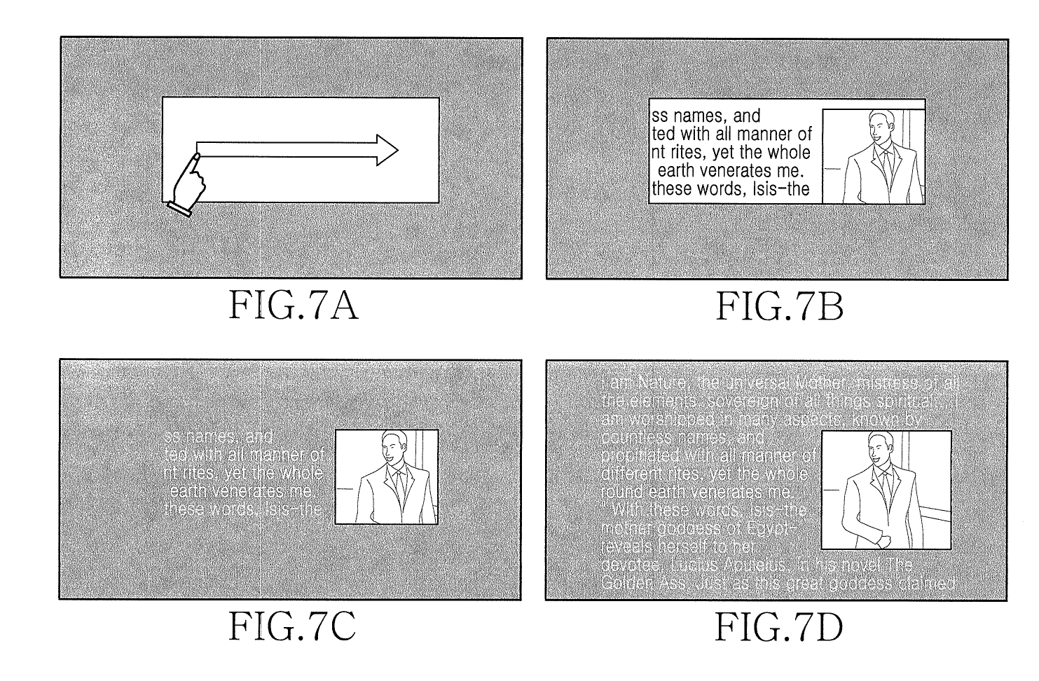

FIG. 7A-D illustrate an operation process of the disclosure according to an exemplary embodiment of the present disclosure.

In detail, FIG. 7A illustrates a screen in which a user sets a square region through a UI in a state where a screen is blackened. FIG. 7B illustrates a result displayed when applying an existing technique, and illustrates some of the original image of FIG. 3A by turning on pixels of a selected region.

On the other hand, FIG. 7C illustrates one example according to the present disclosure in which the original image is converted according to a state of an image of a corresponding region and UI setting by analyzing a characteristic of a region, i.e., the kind of contents or a state of an image.

FIG. 7C illustrates an example of displaying some of a text and original moving-picture region to which a negative effect is applied. However, because a touch region of FIG. 7A extends over a text region and a video region, it is determined that the text region and the video region are all selected, so the result of FIG. 7D can be displayed.

Accordingly, according to being set for an action of a click, dragging, a tap and the like in the same UI, a different result can be brought about even for the same action.

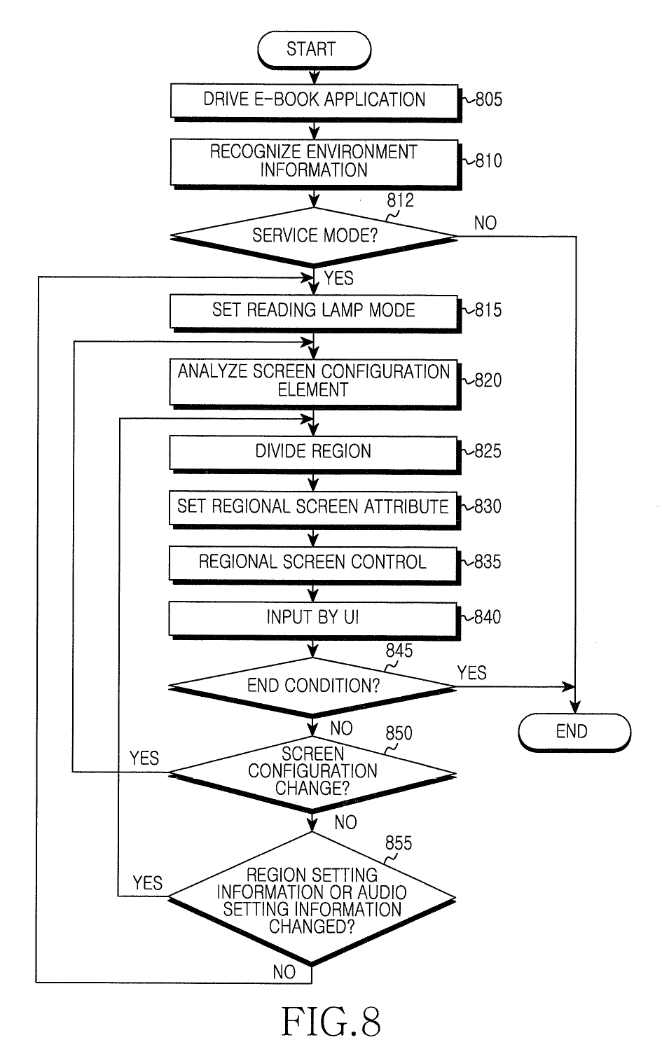

FIG. 8 illustrates an operation for an electronic book (e-book) service according to an exemplary embodiment of the present disclosure.

Referring to FIG. 8, in circumstances where there is a need for attention to light and sound output in a flight, a theater, an office and the like, if a user inquires for contents through an e-book, an apparatus can perform a process as follows.

If the apparatus detects that a user operates an e-book application in the circumstances in step 805, the apparatus can gather present apparatus and user environment information through environment information recognition in step 810.

For example, if the apparatus is set to a flight mode, a manner mode, a security mode and the like or surroundings are now very dark as perceived through an optical sensor or a service mode such as a reading lamp mode is set in step 812, in step 815, the apparatus sets an e-book use mode to the service mode such as a reading lamp mode. If the service mode is not set in step 812, the service mode is terminated.

Here, the reading lamp mode setting, which performs setting related to a screen output and an audio output, generates region setting information and sets an audio mode.

That is, the apparatus sets how to give a screen attribute of a selected screen region and a non-selected screen region, and sets an audio mode to a silence mode, predetermined volume setting, an earphone output mode and the like, thereby controlling a screen and an audio at a time of display.

For example, in an example of a reading lamp mode, it is desirable that the entire screen is dark. So, a corresponding e-book application can be automatically converted into a full screen mode, a basic color (i.e., a color of a non-selected region) of an e-book application can be set to low luminance or a black color or a pixel Off mode can be set and, in an example of a text, a unit of region selection can be a per-three-row and, in an example of an image, music, and a moving picture, it can be a corresponding window unit, a timer mode can be Off, a volume can be output only to an earphone terminal and the like.

After that, in step 820, the apparatus analyzes a screen configuration element in a present screen and, in step 825, performs region division. This represents division into a region currently selected by a user and a region not selected. Next, in step 830, the apparatus sets pixel-unit screen attribute information of corresponding regions based on preset region setting information according to a regional screen attribute.

Next, in step 835, the apparatus displays on a screen in a pixel unit through regional screen control.

After that, in an example where there is an input by a UI in step 840, the apparatus performs processing according to user input. At this time, the apparatus processes not only the input through the UI but also an event affecting a state of the apparatus such as selected region change by a timer and the like setting a change interval, automatic page turning and the like.

Even the event such as the timer is preset and stored through the UI, so the event is regarded as an input by the UI.

As an end condition by the UI, there are program ending, reading lamp mode off and the like. At a time of ending, it is desirable to restore preset audio setting to the original.

If the end condition is not satisfied in step 845, in step 850, the apparatus determines if it senses a screen configuration change. If sensing, the apparatus returns to step 820 and again performs a screen configuration element analysis process and its subsequent steps.

The screen configuration change can occur by a basic UI control and the like such as zoom-in, zoom-out, page turning and the like of an e-book application, or can occur by a control by a UI such as a selected region change by a timer, a touch, and mouse dragging.

In this example, a position or shape and the like of contents of a screen can be changed or not. Accordingly, a need to newly analyze a screen configuration element is generated.

If only a selected region simply changes without a screen configuration change in step 855, the apparatus returns to step 825 and performs new region division. If there is the screen configuration change in step 855, the apparatus returns to step 815 and sets an e-book mode to a service mode such as a reading lamp mode.

FIG. 8 adds an example where region setting information or audio setting information is changed, and this can be often used in an example of setting through an option menu in an application.

This can be used in an example where timer time adjustment, screen attribute designation dependent on region selection or non-selection, a size of a selected region or a method and the like are freely changed through option setting.

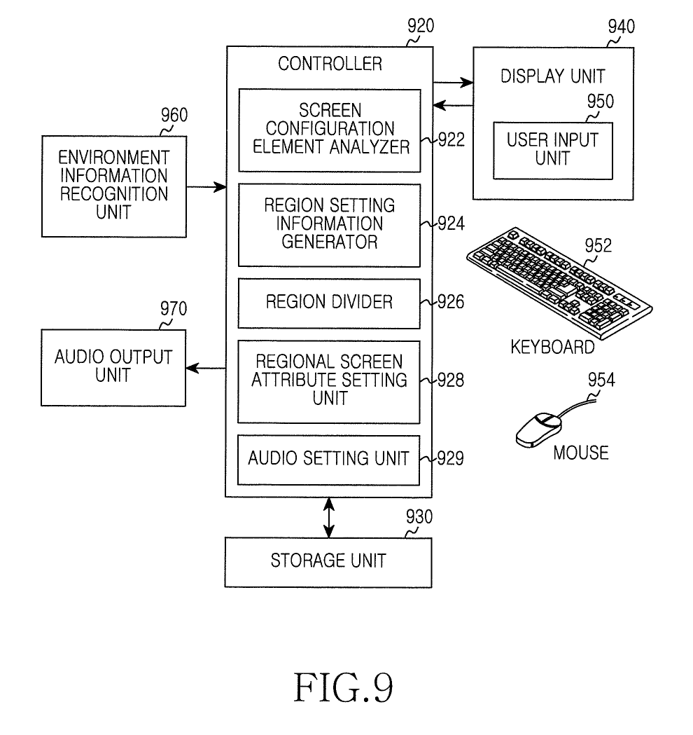

FIG. 9 illustrates a construction of an apparatus according to an exemplary embodiment of the present disclosure.

Referring to FIG. 9, the apparatus according to the exemplary embodiment of the present disclosure includes a controller 920, a storage unit 930, a display unit 940, an environment information recognition unit 960, and an audio output unit 970.

The controller 920 includes a screen configuration element analyzer 922, a region setting information generator 924, a region divider 926, a regional screen attribute generator 928, and an audio setting unit 929.

The display unit 940 can include a user input unit 950 such as a touch panel, and the apparatus can receive a user input through a keyboard 952 or a mouse 954.

The controller 920 controls all operations of the apparatus. That is, the controller 920 controls all operations for analyzing a media stored in the storage unit 930 according to set information, and displaying the analyzed media on the display unit 940 according to a user input provided to the user input unit 950.

Also, the controller 920 can perform functions of the screen configuration element analyzer 922, the region setting information generator 924, the region divider 926, the regional screen attribute generator 928, and the audio setting unit 929.

The storage unit 930 is composed of a storage device enabling information storage such as a Random Access Memory (RAM), a flash memory, a Read Only Memory (ROM), a hard disk and the like, and performs a role of storing data generated during an operation of the controller 920 and also, stores a media used in the apparatus.

The display unit 940 displays image information of a text, a moving picture, an image, etc., like a Liquid Crystal Display (LCD), a Light Emitting Diode (LED), a digital ink, a digital paper, a Cathode Ray Tube (CRT), an Active Matrix Organic Light Emitting Diode (AMOLED), a three-Dimensional (3D) display and the like, and displays information on which the controller 920 controls each pixel according to a set screen attribute.

For objects such as a window, a character, an image, a video, a music application, a frame, a title bar, a status bar, a talk box and the like constituting a screen, the screen configuration element analyzer 922 recognizes attribute information of their colors, positions, kinds, up/down relations, shades, luminance and the like, and stores these object configuration information in the storage unit 930.

For a selected region and a non-selected region, the region setting information generator 924 sets a control method such as attribute information of colors, shades, brightness and the like, timer-related event information, a processing method corresponding to an input of a UI and the like.

The region divider 926 divides a screen displayed on the display unit 940 into one or more regions with reference to screen configuration element information and region setting information provided from the storage unit 930.

For each divided region, the regional screen attribute setting unit 928 sets colors, brightness, and shades of pixels constituting each region with reference to the region setting information stored in the storage unit 930.

At a time the apparatus operates, the audio setting unit 929 sets an audio mode for controlling an audio such as a silence mode, an earphone mode, and a low-sound mode, and stores a corresponding setting value in the storage unit 930.

The user input unit 950 performs a role of receiving, a user input for generating and storing region setting information and region division information. And, a device such as a keypad, a virtual keypad, a keyboard, a mouse, a trackball, a touch screen, a touch pad, a writing recognition device, an eye tracking device, a touch film and the like can be used for user input.

The environment information recognizing unit 960 recognizes environment information such as a predetermined time, a surrounding light amount, a sound level, a flight mode, a vibration mode and the like and thus, changes region attribute setting.

The audio output unit 970 is used for audio output using a speaker, an earphone, and a headphone.

The present disclosure includes a region setting information generating process of, according to a selected region and a non-selected region, giving attribute information of colors, shades, brightness and the like to one or more regions on a screen displayed through the display unit 940, defining a screen control method such as timer-related event information, a processing method corresponding to an input of a UI, and region selection, and storing these information in the storage unit 930.

The present disclosure includes a screen configuration element analyzing process of recognizing attribute information of colors, positions, kinds, up/down relation, shades, luminance and the like for objects such as a window, a character, an image, a video, a music application, a frame, a title bar, a status bar, a talk box and the like, and storing its object configuration information in the storage unit 930.

The present disclosure includes a region dividing process of dividing a screen of the display unit 940 into one or more regions with reference to screen configuration element information and region setting information provided from the storage unit 930.

The present disclosure includes a screen attribute setting process of setting color, brightness, shade, and On/Off information of pixels constituting each region with reference to region setting information and screen configuration element information of the storage unit 930.

The present disclosure includes a screen output process of, according to a set screen attribute, controlling each pixel of the display unit 940 and displaying information.

Also, in the region setting information generating process and the region dividing process, the present disclosure includes a process of receiving a user input from the user input unit 950 for enabling user input such as a keypad, a virtual keypad, a keyboard, a mouse, a track ball, a touch screen, a touch pad, a writing recognition device, an eye tracking device and the like, for the sake of information input.

In the region attribute setting process, the present disclosure includes an environment information recognition process of recognizing environment information such as a predetermined time, a surrounding light amount, a sound level, a flight mode and the like and thus, changing region attribute setting.

In the region setting process, the present disclosure includes an audio mode setting process of setting an audio mode for controlling an audio such as a silence mode, an earphone mode, and a low-sound mode at a time the apparatus operates, and storing a corresponding setting value in the storage unit 930.

In a pixel control process, the present disclosure further includes an audio control process of receiving a corresponding audio mode setting value from the storage unit 930 and controlling an audio output.

The present disclosure can be applied to various services but is more useful, particularly, in an e-book system. The present disclosure can be used in a reading lamp function, a study assistance function and the like of hiding an answer portion at a time of problem solving and the like. And, the present disclosure can be applied to a user information protection function of showing only a specific widget and the like and hiding the remnant widgets and the like in a terminal such as a portable phone, a Portable Multimedia Player (PMP) and the like.

The present disclosure can reduce power consumption of a corresponding device through control such as turning off a region of unnecessary information and the like in a display screen and increase a use time of the corresponding device. This can be a great advantage in a reading device making emphasis on portability such as an e-book.

The present disclosure has an advantage of, by minimizing brightness while displaying only a region desired by a user in a public dark room space such as a flight interior or a reading room, being capable of providing information desired by the user without causing an inconvenience to a third party.

The present disclosure has an advantage that, by turning off the remnant regions excepting some selected regions in a display region of a corresponding electronic device, a user can obtain an effect of hiding and protecting an undesired region against a third party and increasing security. This can be used even for a device such as a desktop computer or a notebook computer, and can provide the same effect as a goggle.

After a non-selected region excepting a region selected by a user is controlled, a user can change a position of a previously selected region through an additional input method. Here, the additional input method can be a direct input method by a user, an automation method by a preset setting value, a network control through wired/wireless and the like. This makes easy the development of various user experiences (UX), thus being capable of easily obtaining information desired by a user under various circumstances mentioned above.

A plurality of region selection are possible in a user input method, so the present disclosure separates an image and a text in using an e-book and, in a state where the remnant regions excepting a specific image region and a specific text region are turned off, automatically moves the text region as fixing the image region, thus being capable of increasing a user convenience.

The present disclosure has an advantage of increasing a use time by reducing power consumption of a corresponding device through control such as turning off a region of unnecessary information in a display device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for selective display, the method comprising:
acquiring region setting information in a display screen;
acquiring a screen configuration element in the display screen;
dividing the display screen into at least one region based on the region setting information and the screen configuration element;
setting a screen attribute to each of the at least one region divided based on the region setting information and the screen configuration element; and
controlling each pixel of the at least one region according to the set screen attribute, and displaying information.

2. The method of claim 1, wherein acquiring the region setting information in the display screen comprises:
acquiring an attribute in a selected region and a non-selected region; and
storing the attribute in a storage unit.

3. The method of claim 2, wherein acquiring the screen configuration element in the display screen comprises:
determining an object constituting the display screen; and
storing a relationship between the object and the attribute in the storage unit.

4. The method of claim 1, wherein setting the screen attribute to the each of the at least one region divided based on the region setting information and the screen configuration element comprises:
setting the screen attribute to each pixel of the at least one region divided using the region setting information, the screen configuration element, and a position of a selected region.

5. The method of claim 4, wherein the screen attribute comprises at least one of colors, brightness, shades, and On/Off.

6. The method of claim 1, wherein acquiring the region setting information and dividing the display screen into the at least one region comprises:
receiving a user input through a User Interface (UI).

7. The method of claim 1, wherein acquiring the region setting information comprises:
generating environment information of a predetermined time, a surrounding light amount, a sound level, and a flight mode; and
recognizing the environment information, and updating the region setting information using the environment information.

8. The method of claim 1, wherein acquiring the region setting information comprises:
setting an audio mode comprising at least one of a silence mode, an earphone mode, and a low-sound mode, and controlling the audio mode; and
storing an audio mode setting value in the storage unit.

9. The method of claim 8, wherein setting the screen attribute comprises:
controlling an audio output using the stored audio mode setting value.

10. The method of claim 1, wherein the display screen is a display screen for one of a mobile phone, a portable multimedia player, and an electronic book reader.

11. An apparatus for selective display, the apparatus comprising:
a region setting information generator configured to acquire region setting information in a display screen;
a screen configuration element analyzer configured to acquire a screen configuration element in the display screen;
a region divider configured to divide the display screen into at least one region based on the region setting information and the screen configuration element;
a regional screen attribute setting unit configured to set a screen attribute to each of the at least one region divided based on the region setting information and the screen configuration element; and
a display unit configured to control each pixel of the at least one region according to the set screen attribute, and display information.

12. The apparatus of claim 11, wherein, to acquire the region setting information in the display screen, the region setting information generator is further configured to:
acquire an attribute in a selected region and a non-selected region, and
store the attribute in a storage unit.

13. The apparatus of claim 12, wherein, to acquire the screen configuration element in the display screen, the screen configuration element analyzer is further configured to:
determine an object constituting the display screen, and
store a relationship between the object and the attribute in the storage unit.

14. The apparatus of claim 11, wherein, to set the screen attribute to the each of the at least one region divided based on the region setting information and the screen configuration element, the regional screen attribute setting unit is further configured to:
set the screen attribute to each pixel of the at least one region divided using the region setting information, the screen configuration element, and a position of a selected region.

15. The apparatus of claim 14, wherein the screen attribute comprises at least one of colors, brightness, shades, and On/Off.

16. The apparatus of claim 11 further comprising a User Interface (UI) configured to receive a user input to acquire the region setting information and divide the display screen into the at least one region.

17. The apparatus of claim 11 further comprising:
an environment information recognition unit configured to when acquiring the region setting information, generate environment information of a predetermined time, a surrounding light amount, a sound level, and a flight mode, and update the region setting information using the environment information.

18. The apparatus of claim 11 further comprising:
an audio setting unit configured to when acquiring the region setting information, set an audio mode comprising at least one of a silence mode, an earphone mode, and a low-sound mode, and controlling the audio mode, and store an audio mode setting value in the storage unit.

19. The apparatus of claim 18 further comprising:
an audio output unit configured to, when setting the screen attribute, control an audio output using the stored audio mode setting value.

20. The apparatus of claim 11, wherein the apparatus is one of a mobile phone, a portable multimedia player, and an electronic book reader.
